(19) United States
(12) Patent Application Publication
(10) Pub. No.: US 2020/0322897 A1
(43) Pub. Date: Oct. 8, 2020

(54) HARQ FEEDBACK AND SIDELINK RSRP REPORT OF GROUPCAST V2X

(71) Applicant: Mediatek Inc., Hsin-Chu (TW)

(72) Inventors: Chien-Hwa Hwang, Hsinchu (TW); Ju-Ya Chen, Hsinchu (TW); Chien-Yi Wang, Hsinchu (TW); Pei-Kai Liao, Hsinchu (TW)

(21) Appl. No.: 16/835,584

(22) Filed: Mar. 31, 2020

Related U.S. Application Data
(60) Provisional application No. 62/827,911, filed on Apr. 2, 2019.
(60) Provisional application No. 62/842,672, filed on May 3, 2019.

(51) Int. Cl. H04W 52/24; H04L 5/00; H04W 24/10; H04L 1/18; H04W 52/28

(52) U.S. Cl. CPC H04W 52/245; H04L 5/0048; H04W 52/283; H04L 1/1812; H04W 24/10

(57) ABSTRACT

In an aspect of the disclosure, a method, a computer-readable medium, and an apparatus are provided. The apparatus may be a transmitting UE. The transmitting UE transmits a reference signal and data to one or more receiving UEs. The transmitting UE receives one or more response signals from the one or more receiving UEs on a particular resource element. Each of the one or more response signals represents at least one of (a) a respective indication based on a measurement at a respective receiving UE, of the one or more receiving UEs, transmitting the each response signal and (b) a respective acknowledgment from the respective receiving UE associated with the data. The transmitting UE determines a transmission power at the transmitting UE based on the respective indications. The transmitting UE transmits data to the one or more receiving UEs at the transmission power.

### CROSS-REFERENCE TO RELATED APPLICATION(S)

This application claims the benefits of U.S. Provisional Application Ser. No. 62/827,911, entitled “V2X PHYSICAL LAYER PROCEDURE and filed on Apr. 2, 2019; and U.S. Provisional Application Ser. No. 62/842,672, entitled “HARQ FEEDBACK AND SIDELINK RSRP REPORT OF GROUPCAST V2X” and filed on May 3, 2019; all of which are expressly incorporated by reference herein in their entirety.

### BACKGROUND

### Field

The present disclosure relates generally to communication systems, and more particularly, to techniques of transmitting acknowledgement messages and Reference Signal Receive Power (RSRP) reports from receiver user equipments (UEs) to a transmitter UE (or transmitting UE) in V2X groupcast.

### Background

The statements in this section merely provide background information related to the present disclosure and may not constitute prior art.

Vehicle-to-Everything (V2X) communication involves the wireless exchange of information between not only vehicles themselves, but also between vehicles and external systems, such as streetlights, buildings, pedestrians, and wireless communication networks. V2X systems enable vehicles to obtain information related to the weather, nearby accidents, road conditions, activities of nearby vehicles and pedestrians, objects nearby the vehicle, and other pertinent information that may be utilized to improve the vehicle driving experience and increase vehicle safety.

Two primary technologies that may be used by V2X networks include dedicated short-range communication (DSRC) based on IEEE 802.1 1p standards and cellular V2X (C-V2X) based on Long Term Evolution (LTE) and/or 5G (New Radio) standards. C-V2X is designed to be compatible with both 4G LTE and emerging New Radio (NR) technologies, enabling C-V2X devices to support both C-V2X connections and LTE and/or NR connections.

As the demand for V2X communication increases, research and development continue to advance V2X technologies not only to meet the growing demand for V2X, but also to advance and enhance the V2X performance capability.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a transmitting UE. The transmitting UE transmits a reference signal and data to one or more receiving UEs. The transmitting UE receives one or more response signals from the one or more receiving UEs on a particular resource element. Each of the one or more response signals represents at least one of (a) a respective indication based on a measurement at a respective receiving UE, of the one or more receiving UEs, transmitting the each response signal and (b) a respective acknowledgment from the respective receiving UE associated with the data. The transmitting UE determines a transmission power at the transmitting UE based on the respective indications. The transmitting UE transmits data to the one or more receiving UEs at the transmission power.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2 illustrates an example of a vehicle-to-everything (V2X) wireless communication network.

FIG. 3 illustrates an exemplary subframe.

FIG. 4 is a block diagram illustrating an example of a V2X controller according to some aspects of the present disclosure.

FIG. 5 is a block diagram illustrating an example of a hardware implementation for a V2X device employing a processing system.

FIG. 6 is a diagram illustrating communications among UEs that are each on a vehicle.

FIG. 7 is a diagram illustrating phase locations of modulation symbols carried in certain resource elements.

FIG. 8 is another diagram illustrating phase locations of modulation symbols carried in certain resource elements.

FIG. 9 is a flow chart of a method (process) for determining a transmission power.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

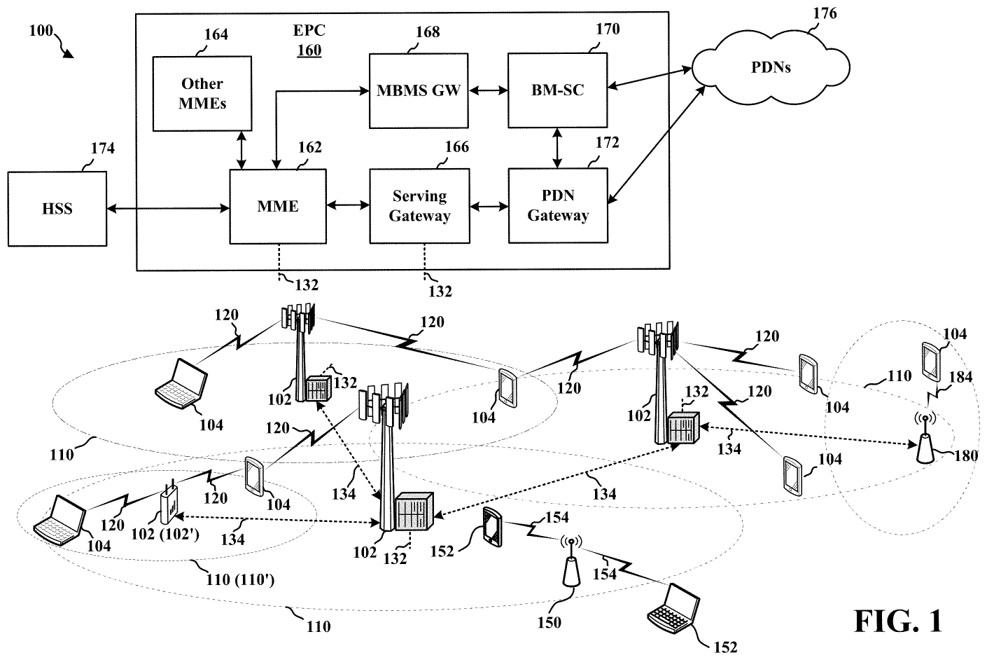

FIG. 1 is a diagram illustrating an example of a wireless communications system and an access network 100. The wireless communications system (also referred to as a wireless wide area network (WWAN)) includes base stations 102, UEs 104, and a core network 160. The base stations 102 may include macro cells (high power cellular base station) and/or small cells (low power cellular base station). The macro cells include base stations. The small cells include femtocells, picocells, and microcells.

The base stations 102 (collectively referred to as Evolved Universal Mobile Telecommunications System (UMTS) Terrestrial Radio Access Network (E-UTRAN)) interface with the core network 160 through backhaul links 132 (e.g., S1 interface). In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the core network 160) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macro cells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100 MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or less carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

The gNodeB (gNB) 180 may operate in millimeter wave (mmW) frequencies and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band has extremely high path loss and a short range. The mmW base station 180 may utilize beamforming 184 with the UE 104 to compensate for the extremely high path loss and short range.

The core network 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the core network 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service (PSS), and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The base station may also be referred to as a gNB, Node B, evolved Node B (eNB), an access point, a base transceiver station, a radio base station, a radio transceiver, a transceiver function, a basic service set (BSS), an extended service set (ESS), or some other suitable terminology. The base station 102 provides an access point to the core network 160 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a toaster, or any other similar functioning device. Some of the UEs 104 may be referred to as IoT devices (e.g., parking meter, gas pump, toaster, vehicles, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

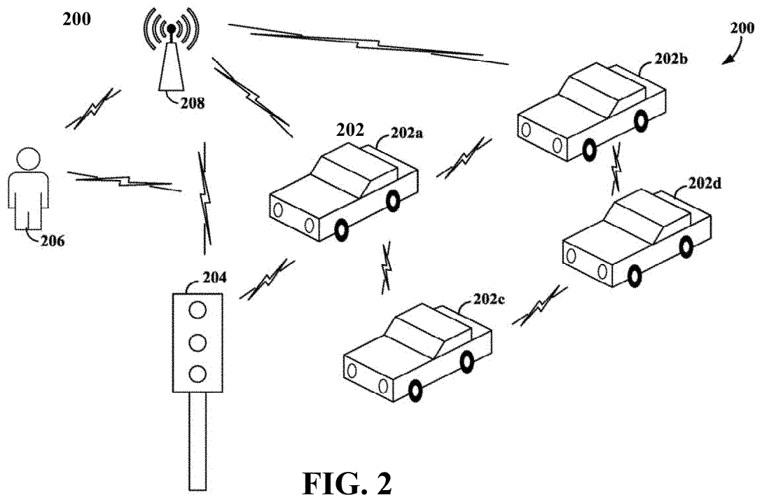

FIG. 2 illustrates an example of a vehicle-to-everything (V2X) wireless communication network 200. A V2X network can connect vehicles 202a-202d to each other (vehicle-to-vehicle (V2V)), to roadway infrastructure 204/205 (vehicle-to-infrastructure (V20), to pedestrians/cyclists 206 (vehicle-to-pedestrian (V2P)), and/or to the network 208 (vehicle-to-network (V2N)).

A V2I transmission may be between a vehicle (e.g., vehicle 202a) and a roadside unit (RSU) 204, which may be coupled to various infrastructure 205, such as a traffic light, building, streetlight, traffic camera, tollbooth, or other stationary object. The RSU 204 may act as a base station enabling communication between vehicles 202a-202d, between vehicles 202a-202d and the RSU 204 and between vehicles 202a-202d and mobile devices of pedestrians/cyclists 206. The RSU 204 may further exchange V2X data gathered from the surrounding environment, such as a connected traffic camera or traffic light controller, V2X connected vehicles 202a-202d, and mobile devices of pedestrians/cyclists 206, with other RSUs 204 and distribute that V2X data to V2X connected vehicles 202a-202d and pedestrians 206. Examples of V2X data may include status information (e.g., position, speed, acceleration, trajectory, etc.) or event information (e.g., traffic jam, icy road, fog, pedestrian crossing the road, collision, etc.), and may also include video data captured by a camera on a vehicle or coupled to an RSU 204.

Such V2X data may enable autonomous driving and improve road safety and traffic efficiency. For example, the exchanged V2X data may be utilized by a V2X connected vehicle 202a-202d to provide in-vehicle collision warnings, road hazard warnings, approaching emergency vehicle warnings, pre-crash or post-crash warnings and information, emergency brake warnings, traffic jam ahead warnings, lane change warnings, intelligent navigation services, and other similar information. In addition, V2X data received by a V2X connected mobile device 206 of a pedestrian/cyclist may be utilized to trigger a warning sound, vibration, flashing light, etc., in case of imminent danger.

V2N communication may utilize traditional cellular links to provide cloud services to a V2X device (e.g., within a vehicle 202a-202d or RSU 204, or on a pedestrian 206) for latency-tolerant use cases. For example, V2N may enable a V2X network server to broadcast messages (e.g., weather, traffic, or other information) to V2X devices over a wide area network and may enable V2X devices to send unicast messages to the V2X network server. In addition, V2N communication may provide backhaul services for RSUs 204.

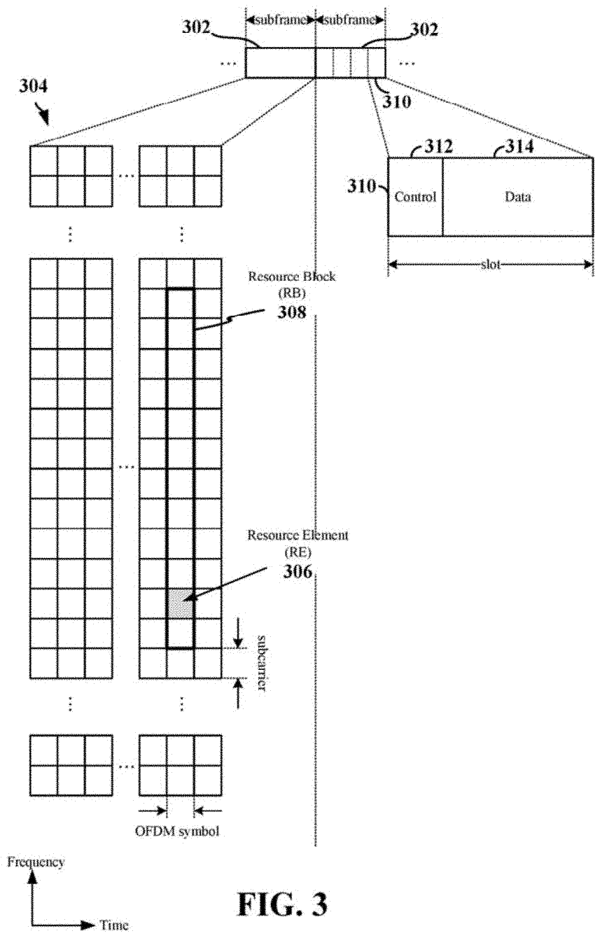

Various aspects of the present disclosure will be described with reference to an OFDM waveform, schematically illustrated in FIG. 3. It should be understood by those of ordinary skill in the art that the various aspects of the present disclosure may be applied to an SC-FDMA waveform in substantially the same way as described herein below. That is, while some examples of the present disclosure may focus on an OFDM link for clarity, it should be understood that the same principles may be applied as well to SC-FDMA waveforms.

Referring now to FIG. 3, an expanded view of an exemplary subframe 302 is illustrated, showing an OFDM resource grid. However, as those skilled in the art will readily appreciate, the PHY transmission structure for any particular application may vary from the example described here, depending on any number of factors. Here, time is in the horizontal direction with units of OFDM symbols; and frequency is in the vertical direction with units of subcarriers.

The resource grid 304 may be used to schematically represent time-frequency resources for a given antenna port. That is, in a multiple-input-multiple-output (MIMO) implementation with multiple antenna ports available, a corresponding multiple number of resource grids 304 may be available for communication. The resource grid 304 is divided into multiple resource elements (REs) 306. An RE, which is 1 subcarrier×1 symbol, is the smallest discrete part of the time-frequency grid, and contains a single complex value representing data from a physical channel or signal. Depending on the modulation utilized in a particular implementation, each RE may represent one or more bits of information. In some examples, a block of REs may be referred to as a physical resource block (PRB) or more simply a resource block (RB) 308, which contains any suitable number of consecutive subcarriers in the frequency domain. In one example, an RB may include 12 subcarriers, a number independent of the numerology used. In some examples, depending on the numerology, an RB may include any suitable number of consecutive OFDM symbols in the time domain. Within the present disclosure, it is assumed that a single RB such as the RB 308 entirely corresponds to a single direction of communication (either transmission or reception for a given device).

Scheduling of UEs or V2X devices for downlink, uplink, or sidelink transmissions typically involves scheduling one or more resource elements 306 within one or more sub-bands. Thus, a UE or V2X device generally utilizes only a subset of the resource grid 304. In some examples, an RB may be the smallest unit of resources that can be allocated to a UE/V2X device. Thus, the more RBs scheduled for a UE/V2X device, and the higher the modulation scheme chosen for the air interface, the higher the data rate for the UE/V2X device.

In this illustration, the RB 308 is shown as occupying less than the entire bandwidth of the subframe 302, with some subcarriers illustrated above and below the RB 308. In a given implementation, the subframe 302 may have a bandwidth corresponding to any number of one or more RBs 308. Further, in this illustration, the RB 308 is shown as occupying less than the entire duration of the subframe 302, although this is merely one possible example. Each 1 ms subframe 302 may consist of one or multiple adjacent slots. In the example shown in FIG. 3, one subframe 302 includes four slots 310, as an illustrative example. In some examples, a slot may be defined according to a specified number of OFDM symbols with a given cyclic prefix (CP) length. For example, a slot may include 7 or 14 OFDM symbols with a nominal CP. Additional examples may include mini slots having a shorter duration (e.g., one to three OFDM symbols). These mini-slots may in some cases be transmitted occupying resources scheduled for ongoing slot transmissions for the same or for different UEs. Any number of resource blocks may be utilized within a subframe or slot.

An expanded view of one of the slots 310 illustrates the slot 310 including a control region 312 and a data region 314. In general, the control region 312 may carry control channels, and the data region 314 may carry data channels. Of course, a slot may contain all DL, all UL, or at least one DL portion and at least one UL portion. The structure illustrated in FIG. 3 is merely exemplary in nature, and different slot structures may be utilized, and may include one or more of each of the control region(s) and data region(s).

Although not illustrated in FIG. 3, the various REs 306 within a RB 308 may be scheduled to carry one or more physical channels, including control channels, shared channels, data channels, etc. Other REs 306 within the RB 308 may also carry pilots or reference signals, including but not limited to a demodulation reference signal (DMRS) a control reference signal (CRS), or a sounding reference signal (SRS). These pilots or reference signals may provide for a receiving device to perform channel estimation of the corresponding channel, which may enable coherent demodulation/detection of the control and/or data channels within the RB 308.

In some examples, the slot 310 may be utilized for broadcast or unicast communication. In V2X networks, a broadcast communication may refer to a point-to-multipoint transmission by one V2X device (e.g., a vehicle, roadside unit (RSET), EGE of a pedestrian/cyclist, or other V2X device) to other V2X devices. A unicast communication may refer to a point-to-point transmission by one V2X device (e.g., a vehicle, roadside unit (RSET), UE of a pedestrian/cyclist, or other V2X device) to a single other V2X device.

In an example, the control region 312 of the slot 310 may include a physical downlink control channel (PDCCH) including downlink control information (DCI) transmitted by an RSU (base station) towards one or more of a set of V2X devices nearby the RSU. In some examples, the DCI may include synchronization information to synchronize communication by a plurality of V2X devices on the V2X channel. In addition, the DCI may include scheduling information indicating one or more resource blocks within the control region 312 and/or data region 314 allocated to V2X devices for device-to-device (D2D) or sidelink communication. For example, the control region 312 of the slot may further include control information transmitted by V2X devices over the sidelink V2X channel, while the data region 314 of the slot 310 may include V2X data transmitted by V2X devices over the sidelink V2X channel. In some examples, the control information may be transmitted within a physical sidelink control channel (PSCCH), while the data may be transmitted within a physical sidelink shared channel (PSSCH).

These physical channels described above are generally multiplexed and mapped to transport channels for handling at the medium access control (MAC) layer. Transport channels carry blocks of information called transport blocks (TB). The transport block size (TBS), which may correspond to a number of bits of information, may be a controlled parameter, based on the modulation and coding scheme (MCS) and the number of RBs in a given transmission.

The channels or carriers illustrated in FIG. 3 are not necessarily all of the channels or carriers that may be utilized between V2X devices, and those of ordinary skill in the art will recognize that other channels or carriers may be utilized in addition to those illustrated, such as other traffic, control, and feedback channels.

Within a V2X network, such as the V2X network 200 illustrated in FIG. 2, the number of V2X packets that may be received and processed by a V2X device within a subframe 302 or slot 310 is directly related to the number of other nearby V2X devices broadcasting packets in the network. However, the modem system on chip (SoC) within devices that support both V2X and other communication protocols, such as LTE (4G) and NR (5G), may be limited in the amount of traffic (packets) that may be processed within a subframe 302 or slot 310 due to limitations in the performance capability and thermal power envelope. Therefore, as the number of V2X devices, and correspondingly, the number of broadcast V2X packets increases, a receiving V2X device may be unable to properly decode all of the received packets or may shut down, thus resulting in missed V2X data.

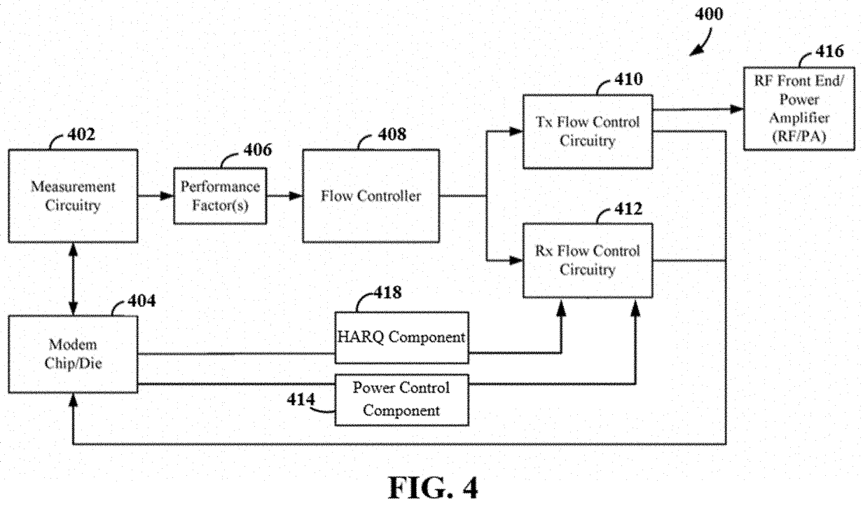

FIG. 4 is a block diagram illustrating an example of a V2X controller 400 according to some aspects of the present disclosure. The V2X controller 400 includes measurement circuitry 402 and a flow controller 408. The measurement circuitry 402 is coupled to a modem chip/die 404 (e.g., a modem SoC) supporting at least V2X communication. In some examples, the modem chip/die 404 may further support 4G (LTE) and/or 5G (NR) cellular communication. The measurement circuitry 402 is configured to measure at least one performance factor 406 related to the modem chip/die 404 and to provide the measured performance factor 406 to the flow controller 408. In some examples, the performance factor 406 may include one or more of a temperature, processor utilization percentage, throughput, or power consumption of the modem chip/die 404.

The flow controller 408 may instruct transmit flow control circuitry 410 and receive flow control circuitry 412 to control at least one characteristic related to the transmission and/or reception of V2X packets based on the at least one measured performance factor 406. For example, the flow controller 408 may instruct the transmit flow control circuitry 410 to control one or more of a transmit power of an RF Front End/Power Amplifier (RF/PA) 416, a transmit packet flow rate of the modem chip/die 404, a type of transmit packets allowed to be transmitted by the modem chip/die 404, or a modulation and coding scheme (MCS) and number of resource blocks (RBs) selected for each of the transmit packets allowed to be transmitted based on the at least one performance factor 406. For example, the transmit flow control circuitry 410 may instruct the modem chip/die 404 to utilize a lower MCS and higher number of RBs to reduce the modem power. However, this may result in a higher transmission power of the RF/PA 416.

In addition, the flow controller 408 may further instruct the receive flow control circuitry 412 to control the rate of packet decoding by the modem chip/die 404. In some examples, the receive flow control circuitry 412 may control the rate of PSSCH (V2X data) decoding and/or the rate of PSCCH (V2X control information) decoding in a subframe or slot. For example, the flow controller 408 may determine a maximum number of packets allowed to be decoded in a subframe or slot and provide the maximum number of packets to the receive flow control circuitry 412. The receive flow control circuitry 412 may then determine a number of packets included in a subframe or slot (e.g., based on received control information from other nearby V2X devices) and select less than all of the received packets for decoding when the number of packets included in the subframe or slot is greater than the maximum number of packets. Thus, the receive flow control circuitry 412 may prevent the modem chip/die 404 from decoding a remaining number of packets above the maximum number of packets.

In some examples, the subset or second list (whitelist) is updated each subframe or slot to include only those V2X devices that transmitted a packet in that subframe or slot. In this example, the number of packets decoded may be less than the maximum number of packets allowed to be decoded when the second list includes less than the maximum number of V2X devices. Otherwise, the number of packets decoded may be equal to the maximum number of packets allowed to be decoded.

The V2X controller 400 includes a power control component 414 and a HARQ component 418. The power control component 414 transmits a reference signal and data to one or more receiving UEs. The power control component 414 receives one or more response signals from the one or more receiving UEs on a particular resource element. Each of the one or more response signals represents a respective indication based on a measurement at a respective receiving UE, of the one or more receiving UEs, transmitting the each response signal. The HARQ component 418 receives a respective acknowledgment from the respective receiving UE associated with the data.

The power control component 414 and the HARQ component 418 detect first at least one response signal having a first phase on the particular resource element to obtain the at least one of the respective indication and the respective acknowledgment associated with the first at least one response signal. The power control component 414 and the HARQ component 418 detect second at least one response signal having a second phase on the particular resource element to obtain the at least one of the respective indication and the respective acknowledgment associated with the second at least one response signal.

In certain configurations, the respective indication represented by the each response signal indicates a predetermined range of Reference Signal Receive Power (RSRP) in which a respective associated RSRP is, the respective associated RSRP being obtained by measuring the reference signal at a corresponding receiving UE, of the one or more receiving UEs, transmitting the each response signal. In certain configurations, the respective indication represented by the each response signal indicates a predetermined range of distance in which a respective associated distance is, the respective associated distance being obtained based on (a) location information of the transmitting UE and (b) location information of a corresponding receiving UE, of the one or more receiving UEs, transmitting the each response signal. In certain configurations, the acknowledgment represented by the each response signal acknowledges one of (a) that corresponding data has been successfully received at a corresponding receiving UE, of the one or more receiving UEs, transmitting the each response signal or (b) that the corresponding data has not been successfully received at the corresponding receiving UE.

The power control component 414 receives second one or more response signals from the one or more receiving UEs on a second particular resource element, each of the second one or more response signals representing the respective indication based on the measurement of the reference signal at the corresponding receiving UE. The HARQ component 418 receives a respective second acknowledgment from the respective receiving UE. The power control component 414 detects third at least one response signal having a third phase on the second particular resource element to obtain at least one of the indication and the second acknowledgment associated with the third at least one response signal. In certain configurations, the second acknowledgment represented by the each second response signal acknowledges the other one of (a) that the corresponding data has been successfully received at the corresponding receiving UE or (b) that the corresponding data has not been successfully received at the corresponding receiving UE.

The power control component 414 determines a transmission power at the transmitting UE based on the respective indications. The power control component 414 instructs the flow controller 408 to transmit data to the one or more receiving UEs at the transmission power.

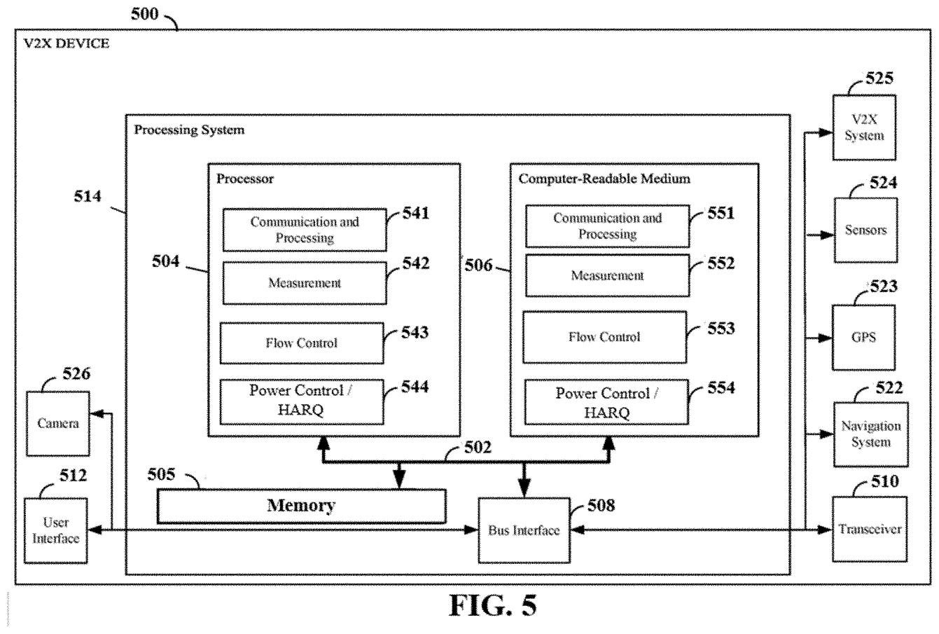

FIG. 5 is a block diagram illustrating an example of a hardware implementation for a V2X device 500 employing a processing system 514. For example, the V2X device 500 may correspond to a vehicle or a mobile or wearable device of a pedestrian/cyclist, as shown and described above in reference to FIG. 2.

The V2X device 500 may be implemented with a processing system 514 that includes one or more processors 504. Examples of processors 504 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the V2X device 500 may be configured to perform any one or more of the functions described herein. That is, the processor 504, as utilized in the V2X device 500, may be used to implement any one or more of the processes and procedures described below.

In this example, the processing system 514 may be implemented with a bus architecture, represented generally by the bus 502. The bus 502 may include any number of interconnecting buses and bridges depending on the specific application of the processing system 514 and the overall design constraints. The bus 502 links together various circuits including one or more processors (represented generally by the processor 504), a memory 505, and computer-readable media (represented generally by the computer-readable medium 506). The bus 502 may also link various other circuits such as timing sources, peripherals, voltage regulators, and power management circuits, which are well known in the art, and therefore, will not be described any further.

A bus interface 508 provides an interface between the bus 502 and a transceiver 510. The transceiver 510 provides a means for communicating with various other apparatus over a transmission medium (e.g., air interface). The bus interface 508 further provides an interface between the bus 502 and a user interface 512 (e.g., keypad, display, touch screen, speaker, microphone, control knobs, etc.). In addition, the bus interface 508 may provide an interface between the bus 502 and one or more peripherals. For example, peripherals may include a navigation system 522, a global positioning system (GPS) receiver 523, one or more sensors 524, a V2X system 525, and/or a camera 526. In the illustrated example, the V2X system 525 is illustrated external to the processing system 514; however, in another example, the V2X system 525 may be internal to the processing system 514, e.g., operational by the processor 504 utilizing software stored on the computer-readable medium 506.

The V2X system 525 may be configured to obtain V2X data from the navigation system 522, GPS receiver 523, sensors 524, and/or camera 526. In addition, the V2X system 525 may be configured to receive V2X data from one or more nearby V2X devices (e.g., vehicles, mobile devices of pedestrians, RSU's, etc., within a range of the V2X system 525) or from a V2X server via the transceiver 510. In some examples, the V2X data may include one or more of a position (e.g., coordinates) of the vehicle and/or nearby vehicle(s), a speed of the vehicle and/or nearby vehicle(s), a trajectory of the vehicle and/or nearby vehicle(s), a route of the vehicle and/or nearby vehicle(s), traffic information, weather information, road hazard information, the location of one or more pedestrians or cyclists, etc. In addition, the V2X data may include video data captured from the camera 526 attached to the V2X device 500 or received from another V2X device. The V2X data may be maintained, for example, within memory 505 and may further be transmitted to another V2X device via the transceiver 510.

The V2X system 525 may further communicate with the user interface 512 to enable a passenger or user in the vehicle cabin to interact with the V2X system 525. For example, the V2X system 525 may provide alerts or other information obtained from the V2X data to the user via the user interface 512. In some examples, the V2X system 525 may further control one or more components (not shown) of the V2X system to facilitate automated driving and/or assisted driving (e.g., control braking and/or steering for collision-avoidance).

The navigation system 522 provides a means for mapping or planning a route to one or more destinations for the V2X device 500. In the illustrated example, the navigation system 522 is illustrated external to the processing system 514; however, in another example, the navigation system 522 may be internal to the processing system 514, e.g., operational by the processor 504 utilizing software stored on the computer-readable medium 506. The GPS receiver 523 provides a means for communicating with a plurality of GPS satellites and determining position, speed, and trajectory information of the V2X device 500. The one or more sensors 524 may include any suitable set of one or more sensors, including, for example, sensors for determining whether the V2X device 500 is braking or accelerating. The set of sensors 524 may further include other types of gauges, such as a speedometer. The camera 526 may include a back-up camera or other camera attached to the V2X device.

The processor 504 is responsible for managing the bus 502 and general processing, including the execution of software stored on the computer-readable medium 506. The software, when executed by the processor 504, causes the processing system 514 to perform the various functions described below for any particular apparatus. The computer-readable medium 506 and the memory 505 may also be used for storing data that is manipulated by the processor 504 when executing software.

One or more processors 504 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

The computer-readable medium 506 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 506 may reside in the processing system 514, external to the processing system 514, or distributed across multiple entities including the processing system 514. The computer-readable medium 506 may be embodied in a computer program product. By way of example, a computer program product may include a computer-readable medium in packaging materials. In some examples, the computer-readable medium 506 may be part of the memory 505. Those skilled in the art will recognize how best to implement the described functionality presented throughout this disclosure depending on the particular application and the overall design constraints imposed on the overall system.

In some aspects of the disclosure, the processor 504 may include circuitry configured for various functions. For example, the processor 504 may include communication and processing circuitry 541 configured to communicate over a V2X channel to exchange V2X data with other nearby V2X devices. The communication and processing circuitry 541 may further be configured to communicate over a 4G (LTE) and/or 5G (NR) channel with a base station (e.g., eNB or gNB). In some examples, the communication and processing circuitry 541 may correspond to the modem chip/die 404 shown in FIG. 4.

The communication and processing circuitry 541 may further operate in coordination with the V2X system 525 to determine whether the V2X device 500 has generated or obtained V2X data to be transmitted to other V2X devices. In addition, the communication and processing circuitry 541 may further be configured to communicate with a V2X server via a base station (e.g., eNB or gNB) over licensed spectrum allocated to an LTE or NR wireless communication network. For example, the communication and processing circuitry 541 may be configured to receive broadcast V2X data (e.g., weather, traffic, map data, etc.) from the V2X server and/or generate and transmit a unicast message to the V2X server for latency-tolerant use cases via the transceiver 510. The communication and processing circuitry 541 may operate in coordination with communication and processing software 551.

The processor 504 may further include measurement circuitry 542 configured to measure at least one performance factor related to the communication and processing circuitry 541. In some examples, the performance factor may include one or more of a temperature, processor utilization percentage, throughput, or power consumption of the communication and processing circuitry 541. In some examples, the measurement circuitry 542 may correspond to the measurement circuitry 402 shown in FIG. 4. The measurement circuitry 542 may operate in coordination with measurement software 552.

The processor 504 may further include flow control circuitry 543 configured to receive the measured performance factor(s) from the measurement circuitry 542 and control at least one characteristic related to the transmission and/or reception of V2X packets based on the at least one measured performance factor. In some examples, the flow control circuitry 543 may correspond to the flow controller 408, transmit flow control circuitry 410, and receive control circuitry 412 shown in FIG. 4.

Thus, the flow control circuitry 543 may control one or more of a transmit power, a transmit packet flow rate, a type of transmit packets allowed to be transmitted, or a modulation and coding scheme (MCS) and number of resource blocks (RBs) selected for each of the transmit packets allowed to be transmitted based on the at least one performance factor. In addition, the flow control circuitry 543 may further control the rate of packet decoding by the communication and processing circuitry 541. In some examples, the flow control circuitry 543 may control the rate of PSSCH (V2X data) decoding and/or the rate of PSCCH (V2X control information) decoding in a subframe or slot.

The flow control circuitry 543 may further modify a number of the nearby V2X devices included in the second list 518 based on the at least one performance factor. For example, the flow control circuitry 543 may increase the number of nearby V2X devices on the second list 518 when the at least one performance factor indicates that the communication and processing circuitry 541 is operating well within the performance capability and thermal power envelope thereof. Similarly, the flow control circuitry 543 may decrease the number of nearby V2X devices on the second list 518 when the at least one performance factor indicates that the performance capability and/or thermal power envelope limits are close to being reached.

The processor 504 may further include power control/HARQ circuitry 544, which correspond to the power control component 414 and the HARQ component 418 described supra in FIG. 4. The power control/HARQ circuitry 544 may operate in coordination with power control/HARQ software 554, which are stored on the computer-readable medium 506.

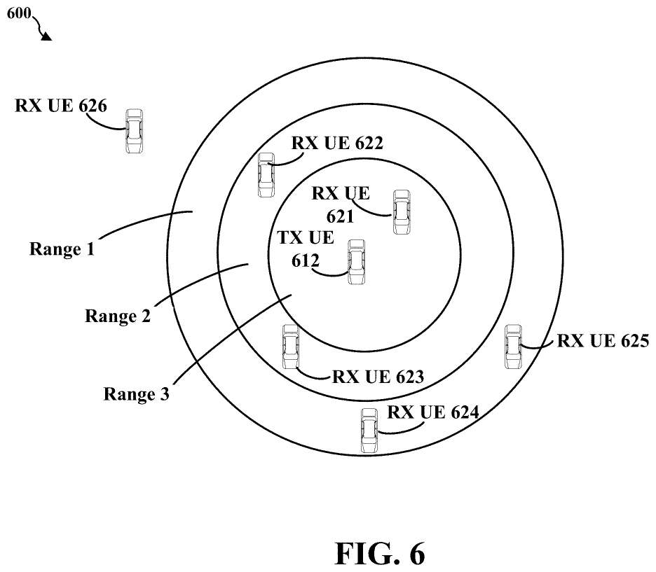

FIG. 6 is a diagram 600 illustrating communications among UEs 612, 621, 622, 623, 624, 625, 626 that are each on a vehicle. In this example, the UE 612 is a transmitter/transmitting (TX) UE. Each of the UEs 621, 622, 623, 624, 625, 626 is a receiver/receiving (RX) UE.

The open-loop power control of the UEs 612, 621, 622, 623, 624, 625, 626 based on the pathloss between a TX UE and RX UE(s) for groupcast communication may utilize techniques described infra. Open-loop power control based on the pathloss may be supported for groupcast. Without this mechanism, the groupcast TX UE may simply perform transmission using the maximum transmit power. In this case, power usage may not be efficient, and high interference may be introduced to the sidelink (SL). When the vehicles carrying the UEs 612, 621, 622, 623, 624, 625, 626 are platooning, the UEs 612, 621, 622, 623, 624, 625, 626 remain in proximity. In this case, the required transmit power level to maintain the communication is generally much lower than the maximum transmit power. Therefore, for groupcast, when pathloss between the TX UE and the RX UE(s) is known to the TX UE, the TX UE can accordingly adjust the transmit power based on the knowledge of pathloss.

In a first technique, for open-loop power control in unicast, the TX UE can transmit the pilot signals, and each RX UE reports the Side Link Reference Signal Receive Power (SL-RSRP) to the TX UE. Based on the reported SL-RSRPs from the RX UEs, the TX UE can derive the pathloss estimate.

In a second technique, for eMBB uplink power control (but not used for SL unicast), the RX UE can transmit pilot signals and also indicate the pilot signal transmit power, and the TX UE derives the pathloss estimate according to the measured pilot signal received power.

For V2X, the first technique described supra may have certain benefits, as the V2X communication is peer-to-peer and many UEs keep moving. The transmit power of data packets as well as the pilot signals may be adjusted frequently. It may not be efficient for the RX UE to signal the transmit power of the pilot signal. Therefore, the first technique used in unicast described supra may be also used for groupcast. That is, for open-loop power control in groupcast based on the pathloss between a TX UE and RX UEs, the TX UE transmits pilot signals, and the RX UEs report the SL-RSRP to the TX UE.

Further, with respect to open-loop power control in unicast and groupcast, if a TX UE is in-coverage, the TX UE derives the transmit power based on the pathloss between the TX UE and the gNB before SL-RSRPs from RX UEs are available; otherwise, the TX UE performs transmission based on the maximum transmit power or a (pre-) configured power level.

In certain configurations, there is no 1-to-many connection establishment for groupcast. Accordingly, groupcast may always be connection-less. But, the 1-to-1 connection procedures may be used for pairs of UEs within the group; for example, each RX UE may have a connection to the TX UE.

For groupcast, the design of reporting/feedback depends on the connection management of groupcast, i.e., whether groupcast is connection-less or connection based. The reporting mechanism of groupcast SL-RSRP by RX UE is to be discussed along with groupcast HARQ feedback in Section 3.

In this example, as described supra, the TX UE 612 transmits reference signals to the RX UEs 621, 622, 623, 624, 625, 626. Upon detecting the reference signals, each of the RX UEs 621, 622, 623, 624, 625, 626 measures the strength/power of the reference signals and determine an RSRP. The UEs 612, 621, 622, 623, 624, 625, 626 may be preconfigured or signaled with different range of RSRPs. In particular, the RX UEs 621, 622, 623, 624, 625, 626 may receive configuration of RSRP ranges from the network or TX UE. Exemplary RSRP ranges are shown in TABLE 1.

TABLE 1

| | |
|---|---|
| RSRP range 1 | RSRP < −120 dBm |
| RSRP range 2 | −120 dBm ≤ RSRP < −110 dBm |
| RSRP range 3 | −110 dBm ≤ RSRP < −100 dBm |
| RSRP range 4 | −100 dBm ≤ RSRP < −90 dBm |
| . . . | . . . |

Based on the measured RSRP value, each of the RX UEs 621, 622, 623, 624, 625, 626 can determine the RSRP range to which the measured RSRP belongs. FIG. 6 shows that the RX UE 621 measured an RSRP in range 3; the RX UE 622 and the RX UE 623 each measured an RSRP in range 2; the RX UE 624 and the RX UE 625 each measured an RSRP in range 1. The UEs having RSRPs in the same range may be considered as in the same subgroup. The RX UE 626 is out of the transmission range of the TX UE 612 and does not detect the reference signals. Accordingly, the RX UE 626 does not need to provide RSRP report due to the large TX-RX geographical distance. For UEs belonging to the same subgroup, as described infra, they can share a common resource (e.g., the same resource element) for SL RSRP feedback. In particular, an RX UE may feedback the RSRP range in which the RSRP of that RX UE is.

Based on the feedback regarding the RSRP ranges, the TX UE 612 can determine the RSRP distribution of RX UEs. The TX UE 612 can adjust the transmit power according to the RSRP distribution. Without such RSRP information, open-loop power control cannot be used, and the TX UE will generally transmit with the maximum power to ensure the coverage. In this case, the interference level in the V2X channel may be unnecessarily high. As such, in one technique, for SL RSRP report of RX UEs in connection-less groupcast, RX UEs are grouped based on the ranges of SL RSRP. RX UEs belonging to the same subgroup may share a resource for SL RSRP feedback.

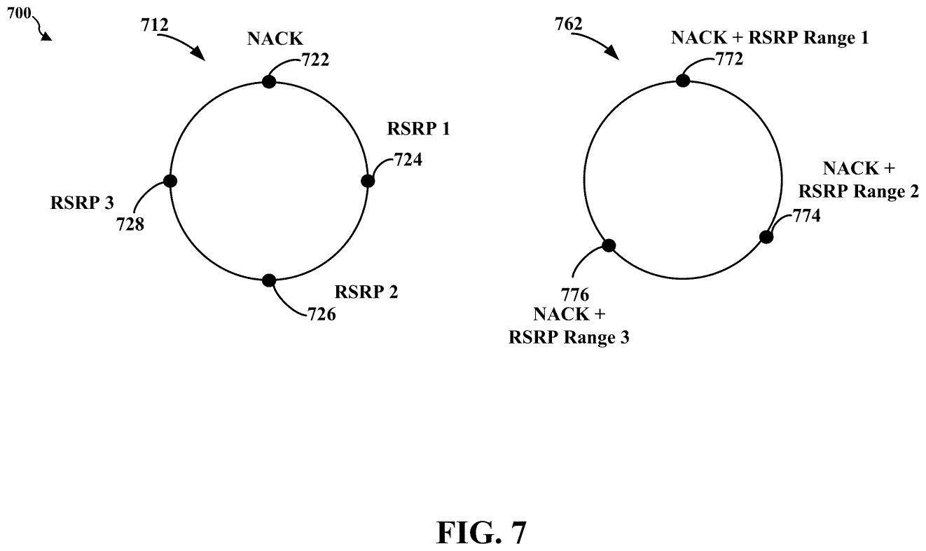

FIG. 7 is a diagram 700 illustrating phase locations of modulation symbols carried in certain resource elements. In certain configurations, the RX UEs 621, 622, 623, 624, 625, 626 may provide joint feedback of HARQ and SL RSRP in groupcast to the TX UE 612. As described supra, the SL RSRP feedback can be used for open-loop power control. For example, the RX UEs 621, 622, 623, 624, 625, 626 can share a Physical Sidelink Feedback Channel (PSFCH).

In one example, all RX UEs 621, 622, 623, 624, 625, 626 share a PSFCH for HARQ feedback. The SL RSRP report can be delivered by PSFCH(s) other than the PSHCH for HARQ feedback. In particular, a modulation symbol 712 is carried in a resource element of the PSFCH. The modulation symbol 712 has phase locations 722, 724, 726, 728 that are utilized by the TX UE 612 and RX UEs 621, 622, 623, 624, 625, 626.

In certain configurations, a sequence-based channel structure may be used for the PSFCH. At the modulation symbol 712, a sequence is used for NACK feedback, and another 3 sequences are used for SL RSRP reports of different subgroups associated with RSRP ranges. In this example, the phase location 722 is used for a NACK. Any one of the RX UEs 621, 622, 623, 624, 625, 626 can transmit a NACK using the modulation symbol 712 at phase location 722 when, for example, that UE has not successfully received a data transmission from the TX UE 612. Any one of the RX UEs 621, 622, 623, 624, 625, 626 that measured an RSRP in the RSRP range 1 can transmit a RSRP report using the modulation symbol 712 at phase location 724. Any one of the RX UEs 621, 622, 623, 624, 625, 626 that measured an RSRP in the RSRP range 2 can transmit a RSRP report using the modulation symbol 712 at phase location 726. Any one of the RX UEs 621, 622, 623, 624, 625, 626 that measured an RSRP in the RSRP range 3 can transmit a RSRP report using the modulation symbol 712 at phase location 728.

As shown, the PSFCH for NACK and the PSFCH for RSRP reports can occupy the same time-frequency resource. It is also possible that the PSFCH for NACK and the PSFCH for RSRP report use different time-frequency resources.

In certain configurations, a subset of the RX UEs 621, 622, 623, 624, 625, 626 may share a PSFCH for HARQ feedback. For example, RX UEs that are with the same RSRP range may share a PSFCH for HARQ feedback at a modulation symbol 762 carried in a resource element. The modulation symbol 762 has phase locations 772, 774, 776 that are utilized by the TX UE 612 and RX UEs 621, 622, 623, 624, 625, 626. In particular, any one of the RX UEs 621, 622, 623, 624, 625, 626 that measured an RSRP in the RSRP range 1 can transmit a RSRP report and a NACK using the modulation symbol 762 at phase location 772. Any one of the RX UEs 621, 622, 623, 624, 625, 626 that measured an RSRP in the RSRP range 2 can transmit a RSRP report and a NACK using the modulation symbol 762 at phase location 774. Any one of the RX UEs 621, 622, 623, 624, 625, 626 that measured an RSRP in the RSRP range 3 can transmit a RSRP report and a NACK using the modulation symbol 762 at phase location 776.

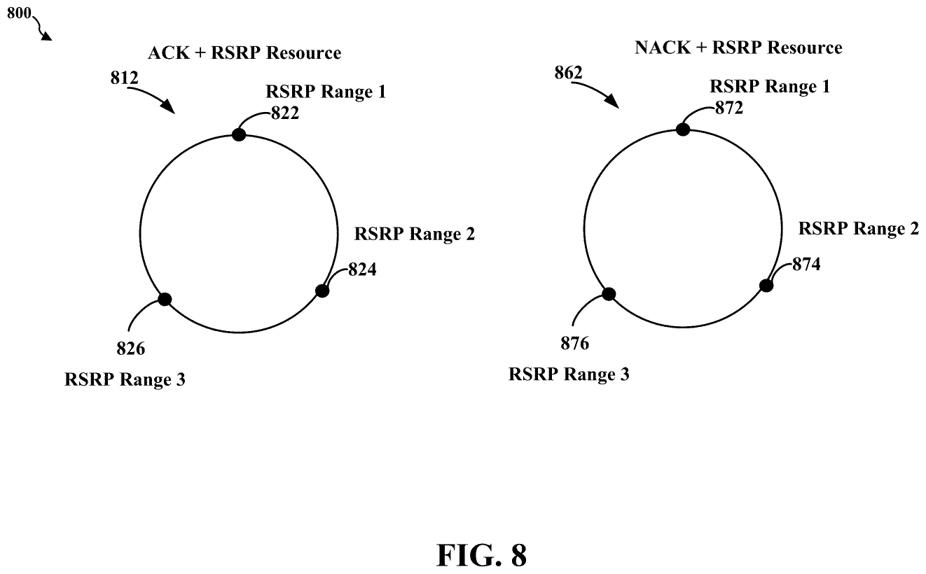

FIG. 8 is a diagram 800 illustrating phase locations of modulation symbols carried in certain resource elements. In certain configurations, all or a subset of RX UEs share a PSFCH for ACK transmission and another PSFCH for NACK transmission.

More specifically, each of the RX UEs 621, 622, 623, 624, 625, 626 may transmit RSRP reports on a modulation symbol 812 in a particular allocated resource element. In other words, an RX UE transmits an RSRP report on the modulation symbol 812 to also indicate an ACK to the TX UE 612. For example, any one of the RX UEs 621, 622, 623, 624, 625, 626 that measured an RSRP in the RSRP range 1 can transmit an RSRP report using the modulation symbol 812 at phase location 822. Any one of the RX UEs 621, 622, 623, 624, 625, 626 that measured an RSRP in the RSRP range 2 can transmit an RSRP report using the modulation symbol 812 at phase location 824. Any one of the RX UEs 621, 622, 623, 624, 625, 626 that measured an RSRP in the RSRP range 3 can transmit an RSRP report using the modulation symbol 812 at phase location 826.

Further, each of the RX UEs 621, 622, 623, 624, 625, 626 may transmit RSRP reports on a modulation symbol 862 in another particular allocated resource element. In other words, an RX UE transmits an RSRP report on the modulation symbol 812 to also indicate a NACK to the TX UE 612. For example, any one of the RX UEs 621, 622, 623, 624, 625, 626 that measured an RSRP in the RSRP range 1 can transmit an RSRP report using the modulation symbol 862 at phase location 872. Any one of the RX UEs 621, 622, 623, 624, 625, 626 that measured an RSRP in the RSRP range 2 can transmit an RSRP report using the modulation symbol 862 at phase location 874. Any one of the RX UEs 621, 622, 623, 624, 625, 626 that measured an RSRP in the RSRP range 3 can transmit an RSRP report using the modulation symbol 862 at phase location 876.

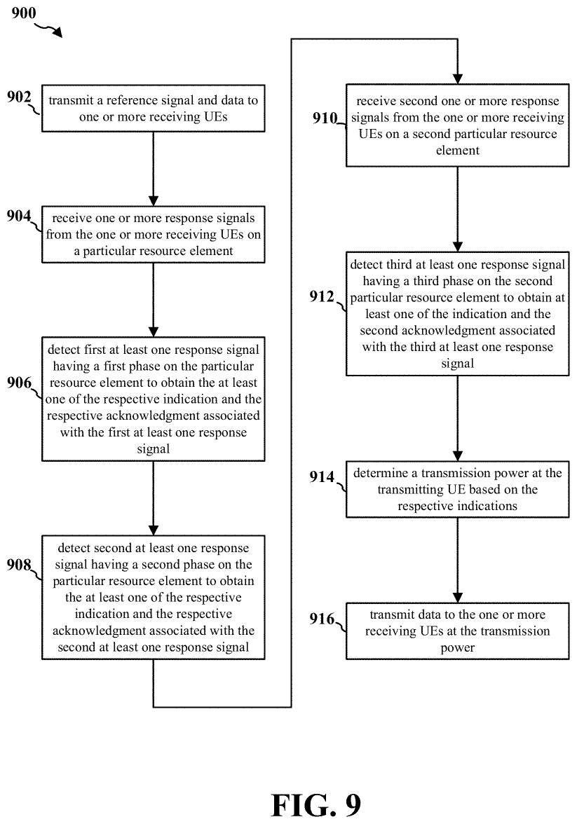

FIG. 9 is a flow chart 900 of a method (process) for determining a transmission power. The method may be performed by a transmitting UE (e.g., the TX UE 612). At operation 902, the transmitting UE transmits a reference signal and data to one or more receiving UEs. At operation 904, the transmitting UE receives one or more response signals from the one or more receiving UEs on a particular resource element. Each of the one or more response signals represents at least one of (a) a respective indication based on a measurement at a respective receiving UE, of the one or more receiving UEs, transmitting the each response signal and (b) a respective acknowledgment from the respective receiving UE associated with the data.

At operation 906, the transmitting UE detects first at least one response signal having a first phase on the particular resource element to obtain the at least one of the respective indication and the respective acknowledgment associated with the first at least one response signal. At operation 908, the transmitting UE detects second at least one response signal having a second phase on the particular resource element to obtain the at least one of the respective indication and the respective acknowledgment associated with the second at least one response signal.

In certain configurations, the respective indication represented by the each response signal indicates a predetermined range of Reference Signal Receive Power (RSRP) in which a respective associated RSRP is, the respective associated RSRP being obtained by measuring the reference signal at a corresponding receiving UE, of the one or more receiving UEs, transmitting the each response signal. In certain configurations, the respective indication represented by the each response signal indicates a predetermined range of distance in which a respective associated distance is, the respective associated distance being obtained based on (a) location information of the transmitting UE and (b) location information of a corresponding receiving UE, of the one or more receiving UEs, transmitting the each response signal. In certain configurations, the acknowledgment represented by the each response signal acknowledges one of (a) that corresponding data has been successfully received at a corresponding receiving UE, of the one or more receiving UEs, transmitting the each response signal or (b) that the corresponding data has not been successfully received at the corresponding receiving UE.

At operation 910, the transmitting UE receives second one or more response signals from the one or more receiving UEs on a second particular resource element, each of the second one or more response signals representing at least one of (a) the respective indication based on the measurement of the reference signal at the corresponding receiving UE and (b) a respective second acknowledgment from the respective receiving UE. At operation 912, the transmitting UE detects third at least one response signal having a third phase on the second particular resource element to obtain at least one of the indication and the second acknowledgment associated with the third at least one response signal. In certain configurations, the second acknowledgment represented by the each second response signal acknowledges the other one of (a) that the corresponding data has been successfully received at the corresponding receiving UE or (b) that the corresponding data has not been successfully received at the corresponding receiving UE.

At operation 914, the transmitting UE determines a transmission power at the transmitting UE based on the respective indications. At operation 916, the transmitting UE transmits data to the one or more receiving UEs at the transmission power.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication of a transmitting user equipment (UE), comprising:
transmitting a reference signal and data to one or more receiving UEs;
receiving one or more response signals from the one or more receiving UEs on a particular resource element, each of the one or more response signals representing at least one of (a) a respective indication based on a measurement at a respective receiving UE, of the one or more receiving UEs, transmitting the each response signal and (b) a respective acknowledgment from the respective receiving UE associated with the data;
determining a transmission power at the transmitting UE based on the respective indications; and
transmitting data to the one or more receiving UEs at the transmission power.

2. The method of claim 1, further comprising
detecting first at least one response signal having a first phase on the particular resource element to obtain the at least one of the respective indication and the respective acknowledgment associated with the first at least one response signal.

3. The method of claim 2, further comprising
detecting second at least one response signal having a second phase on the particular resource element to obtain the at least one of the respective indication and the respective acknowledgment associated with the second at least one response signal.

4. The method of claim 1, wherein the respective indication represented by the each response signal indicates a predetermined range of Reference Signal Receive Power (RSRP) in which a respective associated RSRP is, the respective associated RSRP being obtained by measuring the reference signal at a corresponding receiving UE, of the one or more receiving UEs, transmitting the each response signal.

5. The method of claim 1, wherein the respective indication represented by the each response signal indicates a predetermined range of distance in which a respective associated distance is, the respective associated distance being obtained based on (a) location information of the transmitting UE and (b) location information of a corresponding receiving UE, of the one or more receiving UEs, transmitting the each response signal.

6. The method of claim 1, wherein the acknowledgment represented by the each response signal acknowledges one of (a) that corresponding data has been successfully received at a corresponding receiving UE, of the one or more receiving UEs, transmitting the each response signal or (b) that the corresponding data has not been successfully received at the corresponding receiving UE.

7. The method of claim 6, further comprising:
receiving second one or more response signals from the one or more receiving UEs on a second particular resource element, each of the second one or more response signals representing at least one of (a) the respective indication based on the measurement of the reference signal at the corresponding receiving UE and (b) a respective second acknowledgment from the respective receiving UE; and
detecting third at least one response signal having a third phase on the second particular resource element to obtain at least one of the indication and the second acknowledgment associated with the third at least one response signal.

8. The method of claim 7, wherein the second acknowledgment represented by the each second response signal acknowledges the other one of (a) that the corresponding data has been successfully received at the corresponding receiving UE or (b) that the corresponding data has not been successfully received at the corresponding receiving UE.

9. An apparatus for wireless communication, the apparatus being a transmitting user equipment (UE), comprising:
a memory; and
at least one processor coupled to the memory and configured to:
transmit a reference signal and data to one or more receiving UEs;
receive one or more response signals from the one or more receiving UEs on a particular resource element, each of the one or more response signals representing at least one of (a) a respective indication based on a measurement at a respective receiving UE, of the one or more receiving UEs, transmitting the each response signal and (b) a respective acknowledgment from the respective receiving UE associated with the data;
determine a transmission power at the transmitting UE based on the respective indications; and
transmit data to the one or more receiving UEs at the transmission power.

10. The apparatus of claim 9, wherein the at least one processor is further configured to
detect first at least one response signal having a first phase on the particular resource element to obtain the at least one of the respective indication and the respective acknowledgment associated with the first at least one response signal.

11. The apparatus of claim 10, wherein the at least one processor is further configured to
detect second at least one response signal having a second phase on the particular resource element to obtain the at least one of the respective indication and the respective acknowledgment associated with the second at least one response signal.

12. The apparatus of claim 9, wherein the respective indication represented by the each response signal indicates a predetermined range of Reference Signal Receive Power (RSRP) in which a respective associated RSRP is, the respective associated RSRP being obtained by measuring the reference signal at a corresponding receiving UE, of the one or more receiving UEs, transmitting the each response signal.

13. The apparatus of claim 9, wherein the respective indication represented by the each response signal indicates a predetermined range of distance in which a respective associated distance is, the respective associated distance being obtained based on (a) location information of the transmitting UE and (b) location information of a corresponding receiving UE, of the one or more receiving UEs, transmitting the each response signal.

14. The apparatus of claim 9, wherein the acknowledgment represented by the each response signal acknowledges one of (a) that corresponding data has been successfully received at a corresponding receiving UE, of the one or more receiving UEs, transmitting the each response signal or (b) that the corresponding data has not been successfully received at the corresponding receiving UE.

15. The apparatus of claim 14, wherein the at least one processor is further configured to:
receive second one or more response signals from the one or more receiving UEs on a second particular resource element, each of the second one or more response signals representing at least one of (a) the respective indication based on the measurement of the reference signal at the corresponding receiving UE and (b) a respective second acknowledgment from the respective receiving UE; and
detect third at least one response signal having a third phase on the second particular resource element to obtain at least one of the indication and the second acknowledgment associated with the third at least one response signal.

16. The apparatus of claim 15, wherein the second acknowledgment represented by the each second response signal acknowledges the other one of (a) that the corresponding data has been successfully received at the corresponding receiving UE or (b) that the corresponding data has not been successfully received at the corresponding receiving UE.

17. A computer-readable medium storing computer executable code for wireless communication of a transmitting user equipment (UE), comprising code to:
transmit a reference signal and data to one or more receiving UEs;
receive one or more response signals from the one or more receiving UEs on a particular resource element, each of the one or more response signals representing at least one of (a) a respective indication based on a measurement at a respective receiving UE, of the one or more receiving UEs, transmitting the each response signal and (b) a respective acknowledgment from the respective receiving UE associated with the data;
determine a transmission power at the transmitting UE based on the respective indications; and
transmit data to the one or more receiving UEs at the transmission power.

18. The computer-readable medium of claim 17, wherein the code is further configured to
detect first at least one response signal having a first phase on the particular resource element to obtain the at least one of the respective indication and the respective acknowledgment associated with the first at least one response signal.

19. The computer-readable medium of claim 18, wherein the code is further configured to
detect second at least one response signal having a second phase on the particular resource element to obtain the at least one of the respective indication and the respective acknowledgment associated with the second at least one response signal.

20. The computer-readable medium of claim 17, wherein the respective indication represented by the each response signal indicates a predetermined range of Reference Signal Receive Power (RSRP) in which a respective associated RSRP is, the respective associated RSRP being obtained by measuring the reference signal at a corresponding receiving UE, of the one or more receiving UEs, transmitting the each response signal.
